(19) United States
(12) Patent Application Publication
(10) Pub. No.: US 2013/0310026 A1
(43) Pub. Date: Nov. 21, 2013

(54) PORTABLE ELECTRONIC DEVICE AND INTERNET CONNECTION SETTING METHOD THEREOF

(71) Applicant: ASUSTEK COMPUTER INC., Taipei (TW)

(72) Inventors: Chia-Hui HAN, Taipei (TW); Fu-Chun MAI, Taipei (TW)

(73) Assignee: ASUSTEK COMPUTER INC., Taipei (TW)

(21) Appl. No.: 13/835,550

(22) Filed: Mar. 15, 2013

(30) Foreign Application Priority Data
May 18, 2012 (TW) 101117862

(51) Int. Cl. H04W 76/02

(52) U.S. Cl. CPC H04W 76/021
USPC 455/426.1

(57) ABSTRACT

An internet connection setting method of a portable electronic device includes following steps: establishing a connection between the portable electronic device and a communication electronic device; transferring compatible data from the portable electronic device or the communication electronic device which has the compatible data to the portable electronic device or the communication electronic device without the compatible data via the connection, wherein at least one of the portable electronic device and the communication electronic device has the compatible data; obtaining internet connecting data of the communication electronic device by the portable electronic device via the connection; generating internet setting data by the portable electronic device according to the internet connecting data; setting a connection by the portable electronic device according to the internet setting data; and connecting the portable electronic device to internet via the communication electronic device.

### CROSS-REFERENCE TO RELATED APPLICATION

This application claims the priority benefit of Taiwan application serial No. 101117862, filed on May 18, 2012. The entirety of the above-mentioned patent application is hereby incorporated by reference herein and made a part of specification.

### BACKGROUND OF THE INVENTION

1. Field of the Invention

A portable electronic device and an internet connection setting method. thereof and, more particularly, to a portable electronic device connected to internet via a communication electronic device and an internet connection setting method thereof.

2. Description of the Related Art

As mobile communication technology develops, a portable electronic device, such as a smart phone, can be connected to the internet via a third-generation (3G) wireless network function, and has a wireless network sharing function. Thus, the portable electronic device can be used as a wireless access point (AP) to share the internet to peripheral electronic devices, such as a notebook computer. Thus the peripheral electronic devices can be connected to the internet via the sharing function of the portable electronic device.

Conventionally, the user should manually set network complicatedly before surfing the internet. The user should first enable the wireless network sharing function of a smart phone, and the smart phone provides setting information, such as identification, a password or a service set identifier (SSID). Then, the user should input the information to the notebook computer manually to connect to the internet. It takes much time to set manually and the user may input the complicated identification, the password or the SSID by mistake.

### BRIEF SUMMARY OF THE INVENTION

An internet connection setting method of a portable electronic device includes following steps: establishing a connection between the portable electronic device and a communication electronic device; transferring compatible data from the portable electronic device or the communication electronic device which has the compatible data to the portable electronic device or the communication electronic device without the compatible data via the connection, wherein at least one of the portable electronic device or the communication electronic device has the compatible data; obtaining internet connecting data of the communication electronic device by the portable electronic device via the compatible data; generating internet setting data by the portable electronic device according to the internet connecting data; setting a connection by the portable electronic device according to the internet setting data; and connecting the portable electronic device to internet via the communication electronic device.

A portable electronic device cooperates with a communication electronic device. The portable electronic device includes a processing module and a network module. The processing module generates internet setting data according to internet connecting data, The network module sets a connection according to the internet setting data to connect to internet via the communication electronic device.

A connection is established between the portable electronic device and the communication electronic device. At least one of the portable electronic device and the communication electronic device has compatible data, and the portable electronic device or the communication electronic device which has the compatible data transfers the compatible data to the portable electronic device or the communication electronic device without the compatible data via the connection. The portable electronic device obtains the internet connecting data of the communication electronic device via the connection.

These and other features, aspects and advantages of the present invention will become better understood with regard to the following description, appended claims, and accompanying drawings.

### BRIEF DESCRIPTION OF THE DRAWINGS

FIG. 1 is a flow chart showing an internet connection setting method of a portable electronic device in a first embodiment;

FIG. 2 is a flow chart showing an internet connection setting method of a portable electronic device in a second embodiment; and

FIG. 3 is a schematic diagram showing a portable electronic device in a third embodiment.

### DETAILED DESCRIPTION OF THE EMBODIMENTS

A portable electronic device and an internet connection setting method thereof are illustrated with relating figures, and the same symbols denote the same components.

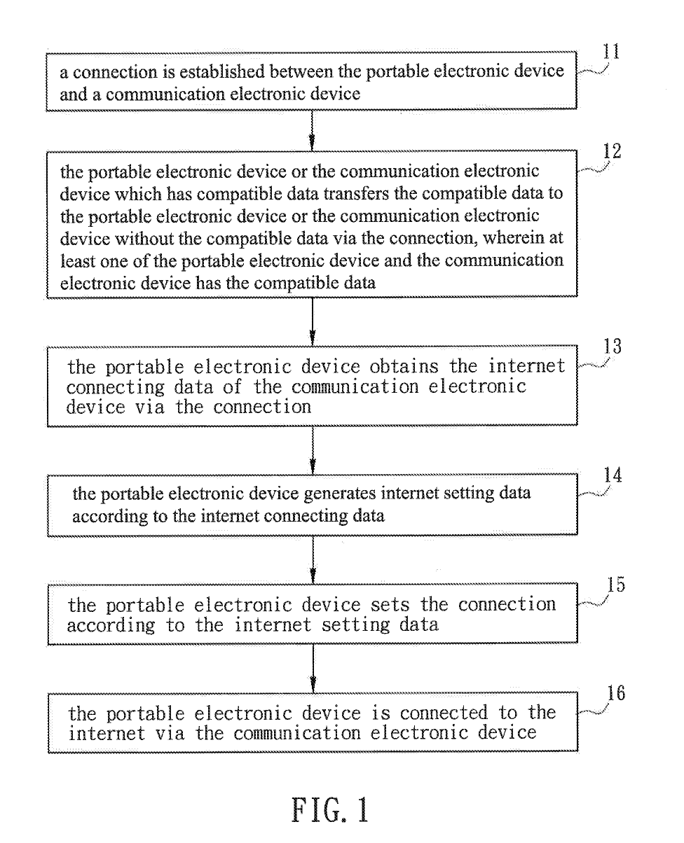

FIG. 1 is a flow chart showing an internet connection setting method of a portable electronic device in a first embodiment.

A connection is established between the portable electronic device and a communication electronic device (step 11).

The portable electronic device may be a notebook computer, a tablet computer or a hand-held computer. The communication electronic device may be an electronic device with a wireless network sharing function, such as a smart phone with a 3G network card, a tablet computer or a hand-held computer.

The portable electronic device may be connected to the communication electronic device in a wired way and transfers data via a universal serial bus (USB). The connection may also be built in a wireless way, such as Bluetooth, infrared radiation (IR), near field communication (NFC) or wireless universal serial bus (WUSB), which is not limited herein.

Moreover, the user can connect the communication electronic device to the portable electronic device for charging via the USB. Thus, when the portable electronic device is connected with the communication electronic device via the USB, the portable electronic device may display a popup window for the user to select whether to set the internet connection to connect the internet.

At least one of the portable electronic device and the communication electronic device has the compatible data. The portable electronic device or the communication electronic device which has compatible data transfers the compatible data to the portable electronic device or the communication electronic device without the compatible data via the connection (step 12).

The compatible data may be any information as long as it is compatible with the communication electronic device and the portable electronic device, and it can make the portable electronic device obtain needed information of the communication electronic device. The compatible data may be an application program. The compatible data may be stored in a storage unit of the portable electronic device or the communication electronic device. The application program is taken as an example of the compatible data hereinafter.

When the connection is built, the portable electronic device with the application program checks whether the communication electronic device includes the application program. If not, the application program is transferred to the communication electronic device. After the application program is transferred, the portable electronic device installs the application program in the communication electronic device and enables the application program after the installation at the same time to make the portable electronic device capable of obtaining information of the communication electronic device.

In another embodiment, the communication electronic device includes the application program, and the portable electronic device does not include the application program. After the connection is built, the communication electronic device transfers the application program to the portable electronic device, installs and then enables the application program. If both the portable electronic device and the communication electronic device include the application program, the application program transferring is not needed, and the portable electronic device can access internet connecting data directly.

The portable electronic device obtains the internet connecting data of the communication electronic device via the connection (step 13).

When the application program is installed to the communication electronic device and is executed, the application program controls the communication electronic device to obtain the internet connecting data, such as identification, a password or an SSID, and transfers the internet connecting data to the portable electronic device. Thus, the portable electronic device obtains the internet connecting data of the communication electronic device, and the connection between the portable electronic device and the communication electronic device can be stopped. The application program may also directly control the portable electronic device to obtain the internet connecting data of the communication electronic device via the connection.

It does not need to manually control the communication electronic device to make the portable electronic device obtain the Internet connecting data. For example, if the communication electronic device is a smart phone, the user does not need to unlock a keyboard of the smart phone, which improves convenience in setting the internet connection.

The portable electronic device generates internet setting data according to the internet connecting data (step 14).

When the portable electronic device obtains the internet connecting data of the communication electronic device, it generates the internet setting data according to the internet connecting data as a basis for the connection setting.

The portable electronic device sets the connection according to the internet setting data (step 15).

The internet setting data includes all the internet connection data for connecting to internet via the communication electronic device. Thus, the portable electronic device finishes internet connection setting of the communication electronic device according to the internet setting data.

The portable electronic device is connected to the internet via the communication electronic device (step 16).

The communication electronic device is used as a wireless network router to share the wireless network with the portable electronic device. When the portable electronic device finishes the connection setting, the portable electronic device can be connected to the internet via the communication electronic device.

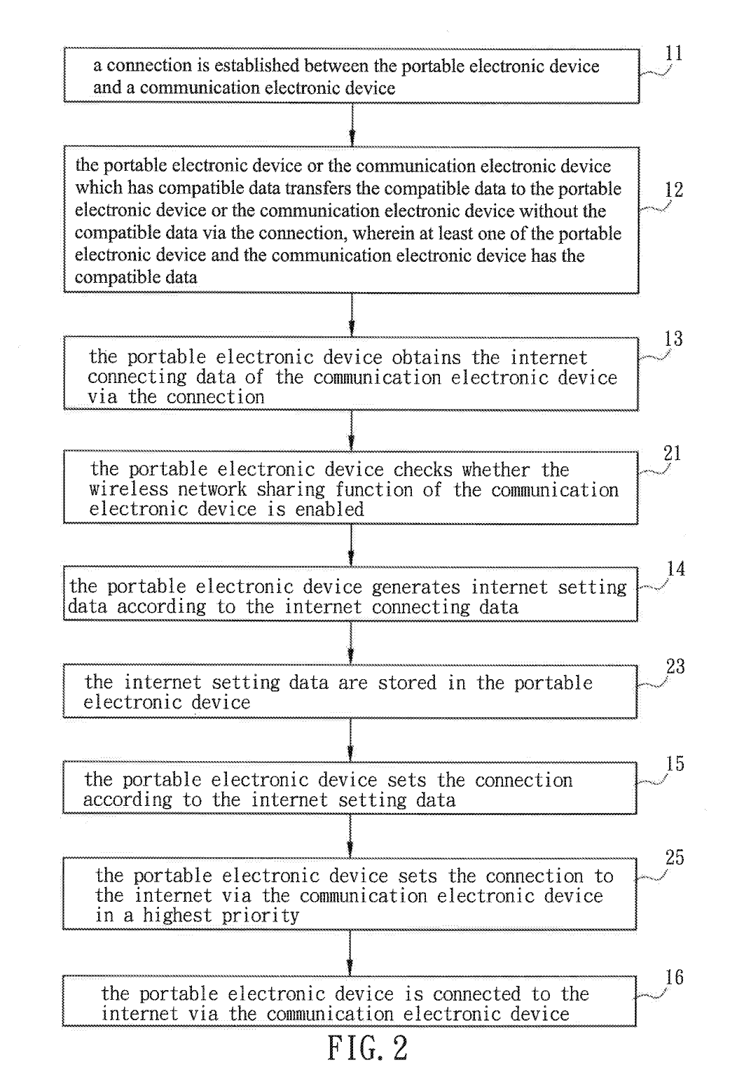

FIG. 2 is a flow chart showing an internet connection setting method of a portable electronic device in a second embodiment. The embodiment is similar to the first embodiment, only added steps are illustrated in the following, and description of the same steps are omitted herein.

The portable electronic device checks whether the wireless network sharing function is enabled at the communication electronic device (step 21). If not, the portable electronic device enables the wireless network sharing function of the communication electronic device via the connection.

If the user does not enable the wireless network sharing function of the communication electronic device, when the portable electronic device and the communication electronic device are connected, the portable electronic device can be used to check and enable the wireless network sharing function of the communication electronic device to make the portable electronic device connected to the internet via the communication electronic device.

The user does not need to enable the wireless network sharing function of the communication electronic device manually. For example, if the communication electronic device is a smart phone, the user does not need to unlock the keyboard of the smart phone, which improves convenience in setting the interact connection.

The internet setting data are stored in the portable electronic device (step 23). Since the interact setting data are stored in the portable electronic device, after the user sets the connection for the first time, the portable electronic device can automatically connect to the internet via the communication electronic device and does not need to set the connection again, which improves convenience in connecting the internet.

The portable electronic device sets the connection to the internet via the communication electronic device in a highest priority (step 25).

When the user carries the portable electronic device and the communication electronic device, the user may mostly use the communication electronic device to connect to the internet. In order to make the portable electronic device find an accessible connection rapidly in every internet connection, the portable electronic device can set the connection to the internet via the communication electronic device in a highest priority.

A portable electronic device applying the internet connection setting method is provided in an embodiment.

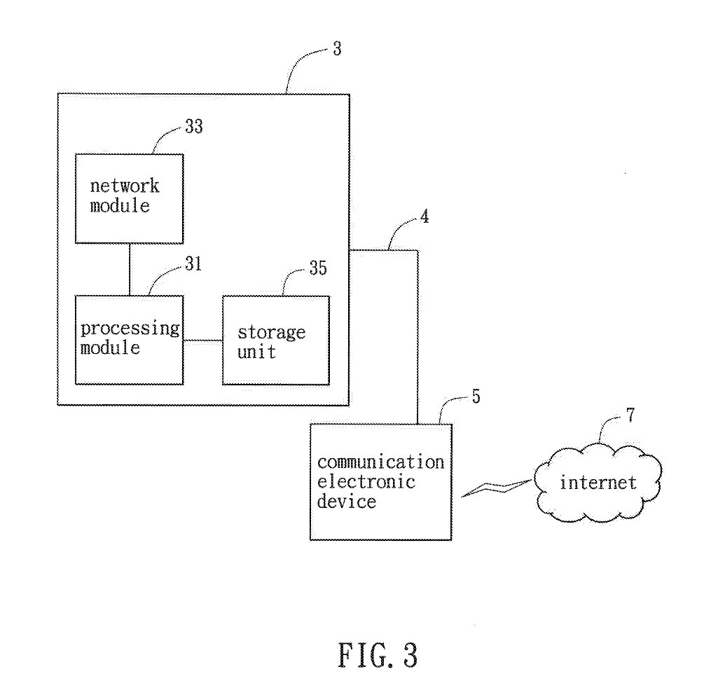

FIG. 3 is a schematic diagram showing a portable electronic device in a third embodiment. The portable electronic device 3 cooperates with a communication electronic device 5, and a connection 4 is built therebetween. The connection 4 may be built in a wireless way or a wired way. The wired way may be a USB way, and the wireless way may be Bluetooth, IR, NFC or WUSB way, which is not limited herein. At least one of the portable electronic device 3 and the communication electronic device 5 includes compatible data, and the portable electronic device 3 or the communication electronic device 5 which has the compatible data transfers the compatible data to the portable electronic device 3 or the communication electronic device 5 without the compatible data via the connection. The portable electronic device 3 obtains internet connecting data, such as identification, a password or an SSID, from the communication electronic device 5 via the connection 4. The portable electronic device 3 includes a processing module 31 and a network module 33.

The processing module 31 generates internet setting data according to the internet connecting data as a basis for the connection setting.

The network module 33 sets the connection according to the internet setting data to connect to the internet 7 via the communication electronic device 5.

Moreover, if the portable electronic device 3 includes the compatible data, the portable electronic device may further includes a storage unit 35 to store the compatible data. The storage unit 35 further stores the internet setting data to help the user to connect to the internet 7 via the communication electronic device 5 more rapidly each time after the user sets the connection for the first time.

In sum, a portable electronic device cooperating with a communication electronic device and an internet connection setting method thereof generate internet setting data automatically and finish the internet connection setting rapidly and correctly, which saves time and avoids troubles in manual setting.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An internet connection setting method of a portable electronic device cooperating with a communication electronic device, wherein at least one of the portable electronic device or the communication electronic device has compatible data, the internet connection setting method comprising following steps:
establishing a connection between the portable electronic device and the communication electronic device;
transferring compatible data from the portable electronic device or the communication electronic device which has the compatible data to the portable electronic device or the communication electronic device without the compatible data via the connection;
obtaining internet connecting data of the communication electronic device by the portable electronic device via the connection;
generating internet setting data by the portable electronic device according to the internet connecting data;
setting a connection by the portable electronic device according to the interne setting data; and
connecting the portable electronic device to internet via the communication electronic device.

2. The internet connection setting method according to claim 1, wherein the connection between the portable electronic device and the communication electronic device is built in a wireless way or a wired way.

3. The internet o n setting method according to claim 1, wherein the internet connection setting method further includes a following step:
setting the connection to the internet via the communication electronic device in a highest priority by the portable electronic device.

4. The internet connection setting method according to claim 1, wherein the internet connection setting method further includes a following step:
checking whether a wireless network sharing function of the communication electronic device is enabled by the portable electronic device; if not, enabling the wireless network sharing function of the communication electronic device by the portable electronic device via the connection.

5. The internet connection setting method according to claim 1, Wherein the internet connection setting method further includes a following step:
storing the internet setting data in the portable electronic device.

6. The internet connection setting method according to claim 1, wherein the compatible data is an application program.

7. A portable electronic device cooperating with a communication electronic device, comprising:
a processing module generating internet setting data according to internet connecting data; and
a network module setting a connection according to the internet setting data and connected to internet via the communication electronic device;
wherein a connection is established between the portable electronic device and the communication electronic device, at least one of the portable electronic device and the communication electronic device has compatible data, the portable electronic device or the communication electronic device which has the compatible data transfers the compatible data to the portable electronic device or the communication electronic device without the compatible data via the connection, and the portable electronic device obtains the internet connecting data of the communication electronic device via the connection.

8. The portable electronic device according to claim 7, wherein the connection between the portable electronic device and the communication electronic device is built in a wireless way or a wired way.

9. The portable electronic device according to claim 7, wherein the portable electronic device further includes a storage unit storing the compatible data and the internet setting data.

10. The portable electronic device according to claim 7, wherein the compatible data is an application program.
